(19) United States
(12) Patent Application Publication
(10) Pub. No.: US 2026/0009632 A1
(43) Pub. Date: Jan. 8, 2026

(54) ANGLE SENSING DEVICE AND METHOD OF CONTROLLING THE SAME

(71) Applicant: HL KLEMOVE CORP., Incheon (KR)

(72) Inventors: Hoo-Chang LEE, Incheon (KR); Kyoung-Chul JO, Incheon (KR)

(21) Appl. No.: 19/069,901

(22) Filed: Mar. 4, 2025

(30) Foreign Application Priority Data
Jul. 4, 2024 (KR) 10-2024-0088350
Nov. 22, 2024 (KR) 10-2024-0168770

(51) Int. Cl. G01B 7/30; B62D 15/02; G01D 5/14; G01D 5/20

(52) U.S. Cl. CPC G01B 7/30; G01D 5/145; G01D 5/20; B62D 15/0215

(57) ABSTRACT

An angle sensing device may include one or more angle sensors, and a controller configured to determine a rotation angle of the steering wheel on the basis of an output signal from the one or more angle sensors in response to turning-on of the vehicle, and on the basis of a comparison of the determined rotation angle, a first reference angle, and a second reference angle smaller than the first reference angle, determine the determined rotation angle as a final rotation angle of the steering wheel or determine the final rotation angle on the basis of a yaw rate acquired through an output signal from a yaw rate sensor of the vehicle.

### CROSS-REFERENCE TO RELATED APPLICATIONS

This application claims the priority of Korean Patent Application No. 10-2024-0088350 filed on Jul. 4, 2024, and Korean Patent Application No. 10-2024-0168770 filed on Nov. 22, 2024, in the Korean Intellectual Property Office, the disclosure of which is incorporated herein by reference.

### BACKGROUND

### Field

The disclosed disclosure relates to an angle sensing device and a method of controlling the same.

### Description of the Related Art

A rotation range of a steering wheel varies depending on purposes of vehicles, weight, and/or manipulation convenience, and an angle sensing device utilizes an angle sensor to determine an absolute angle of a steering wheel.

In the related art, in order to ensure a wide rotation range of the steering wheel with precise performance, a technology has been developed that complementarily applies two angle elements by utilizing a Vernier algorithm and using an angle sensor including two different angle elements.

However, a maximum rotation range, which may be measured by utilizing the technology developed in the related art, is limited. It is impossible to detect a rotation range of the steering wheel that is wider than a maximum rotation range that may be measured by the technology in the related art.

Therefore, there is a need for a technology capable of precisely detecting a rotation range of the steering wheel that is wider than that in the related art.

### SUMMARY

An object to be achieved by the present disclosure is to provide an angle sensing device and a method of controlling the same, the angle sensing device capable of precisely detecting a rotation range of a steering wheel wider than that in the related art.

Another object to be achieved by the present disclosure is to provide an angle sensing device and a method of controlling the same based on a new technology, the angle sensing device capable of detecting a rotation range of a steering wheel greater than a maximum rotation range of the steering wheel that may be determined on the basis of an output value from an angle sensor.

An angle sensing device according to one aspect of the disclosed disclosure may include: one or more angle sensors configured to output an output signal corresponding to a rotation of a steering wheel of a vehicle; and a controller connected to the one or more angle sensors, wherein the controller is configured to: determine a rotation angle of the steering wheel based on the output signal from the one or more angle sensors, and based on a comparison of the determined rotation angle, a first reference angle, and a second reference angle smaller than the first reference angle, determine the determined rotation angle as a final rotation angle of the steering wheel, or determine the final rotation angle based on a yaw rate acquired from a yaw rate sensor of the vehicle in accordance with traveling of the vehicle.

The controller may determine the determined rotation angle as the final rotation angle in response to the determined rotation angle being equal to or less than the first reference angle and being equal to or greater than the second reference angle.

The controller may determine the final rotation angle based on the acquired yaw rate in response to the determined rotation angle being greater than the first reference angle or the determined rotation angle being smaller than the second reference angle.

The controller may determine the determined rotation angle as the final rotation angle in response to the determined rotation angle being greater than the first reference angle, and the yaw rate according to a forward movement of the vehicle being equal to or greater than a first reference yaw rate having a plus value, and determine a value, which is obtained by subtracting a maximum rotation range value of the one or more angle sensors from the determined rotation angle, as the final rotation angle in response to the determined rotation angle being greater than the first reference angle, and the yaw rate according to the forward movement of the vehicle being smaller than the first reference yaw rate.

The controller may determine the determined rotation angle as the final rotation angle in response to the determined rotation angle being greater than the first reference angle, and the yaw rate according to a rearward movement of the vehicle being equal to or smaller than a second reference yaw rate having a minus value, and determine a value, which is obtained by subtracting a maximum rotation range value of the one or more angle sensors from the determined rotation angle, as the final rotation angle in response to the determined rotation angle being greater than the first reference angle, and the yaw rate according to the rearward movement of the vehicle being greater than the second reference yaw rate.

The controller may determine the determined rotation angle as the final rotation angle in response to the determined rotation angle being smaller than the second reference angle, and the yaw rate according to a forward movement of the vehicle being equal to or smaller than a second reference yaw rate having a minus value, and determine a value, which is obtained by adding up the determined rotation angle and a maximum rotation range value of the one or more angle sensors, as the final rotation angle in response to the determined rotation angle being smaller than the second reference angle, and the yaw rate according to the forward movement of the vehicle being greater than the second reference yaw rate.

The controller may determine the determined rotation angle as the final rotation angle in response to the determined rotation angle being smaller than the second reference angle, and the yaw rate according to a rearward movement of the vehicle being equal to or greater than a first reference yaw rate having a plus value, and determine a value, which is obtained by adding up the determined rotation angle and a maximum rotation range value of the one or more angle sensors, as the final rotation angle in response to the determined rotation angle being smaller than the second reference angle, and the yaw rate according to the rearward movement of the vehicle being smaller than the first reference yaw rate.

An angle sensing device according to another aspect of the disclosed disclosure may include: one or more angle sensors configured to output an output signal corresponding to a rotation of a steering wheel of a vehicle; and a controller connected to the one or more angle sensors, in which the controller is configured to: determine a rotation angle of the steering wheel based on the output signal from the one or more angle sensors, and in accordance with a reference angle section including the determined rotation angle among a plurality of reference angle sections, determine the determined rotation angle as a final rotation angle of the steering wheel, or determine the final rotation angle based on a yaw rate acquired from a yaw rate sensor of the vehicle in accordance with traveling of the vehicle.

The controller may determine the determined rotation angle as the final rotation angle in response to the determined rotation angle being included in a first reference angle section among the plurality of reference angle sections. The controller may determine the final rotation angle based on a comparison between the acquired yaw rate and the determined rotation angle, in response to the determined rotation angle being included in a second reference angle section continuous from the first reference angle section among the plurality of reference angle sections.

The controller may determine the determined rotation angle as the final rotation angle, in response to a sign of the acquired yaw rate in accordance with a forward movement of the vehicle being identical to a sign of the determined rotation angle, and determine the final rotation angle based on the determined rotation angle and a width value including the first reference angle section and the second reference angle section, in response to the sign of the acquired yaw rate in accordance with the forward movement of the vehicle being different from the sign of the determined rotation angle.

The controller may determine a value, which is obtained by adding up the determined rotation angle and a width value including the first reference angle section and the second reference angle section, as the final rotation angle, in response to a sign of the acquired yaw rate in accordance with a forward movement of the vehicle being plus and a sign of the determined rotation angle being minus.

The controller may determine a value, which is obtained by subtracting the width value from the determined rotation angle, as the final rotation angle, in response to the sign of the acquired yaw rate in accordance with the forward movement of the vehicle being minus and the sign of the determined rotation angle being plus.

The controller may

determine the determined rotation angle as the final rotation angle, in response to a sign of the acquired yaw rate in accordance with a rearward movement of the vehicle being different from a sign of the determined rotation angle, and determine the final rotation angle based on the determined rotation angle and a width value including the first reference angle section and the second reference angle section, in response to the sign of the acquired yaw rate in accordance with the rearward movement of the vehicle being identical to the sign of the determined rotation angle.

The second reference angle section may include: a first range to a value increased by a preset value from a maximum value of the first reference angle section; and a second range to a value decreased by the preset value from a minimum value of the first reference angle section.

A center value of an entire rotation section of the steering wheel is set to 0, the entire rotation section being a maximum rotation range of the steering wheel that is measurable based on the output signal from the one or more angle sensors, and a width value of the first reference angle section is a value obtained by subtracting a value, which is obtained by dividing a maximum rotation range value of the steering wheel by 2, from a width value of the entire rotation section.

A method of controlling an angle sensing device according to still another aspect of the disclosed disclosure may include: determining a rotation angle of a steering wheel of a vehicle based on an output signal from one or more angle sensors, the output signal corresponding to a rotation of the steering wheel; and based on a comparison of the determined rotation angle, a first reference angle, and a second reference angle smaller than the first reference angle, determining the determined rotation angle as a final rotation angle of the steering wheel, or determining the final rotation angle based on a yaw rate acquired from a yaw rate sensor of the vehicle in accordance with traveling of the vehicle.

The determining of the determined rotation angle as the final rotation angle may be performed in response to the determined rotation angle being equal to or less than the first reference angle and being equal to or greater than the second reference angle, and the determining of the final rotation angle based on the acquired yaw rate is performed in response to the determined rotation angle being greater than the first reference angle or the determined rotation angle being smaller than the second reference angle.

The determining of the final rotation angle based on the acquired yaw rate may include determining the determined rotation angle as the final rotation angle in response to the determined rotation angle being greater than the first reference angle, and the yaw rate according to a forward movement of the vehicle being equal to or greater than a first reference yaw rate having a plus value, or in response to the determined rotation angle being smaller than the second reference angle, and the yaw rate according to the forward movement of the vehicle being equal to or smaller than a second reference yaw rate having a minus value.

The determining of the final rotation angle based on the acquired yaw rate may include: determining a value, which is obtained by subtracting a maximum rotation range value of the one or more angle sensors from the determined rotation angle, as the final rotation angle of the steering wheel in response to the determined rotation angle being greater than the first reference angle, and the yaw rate according to a forward movement of the vehicle being smaller than a first reference yaw rate; and determining a value, which is obtained by adding up the determined rotation angle and the maximum rotation range value, as the final rotation angle of the steering wheel in response to the determined rotation angle being smaller than the second reference angle, and the yaw rate according to the forward movement of the vehicle being greater than a second reference yaw rate.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a sensing device for a steering wheel according to an embodiment angle;

FIG. 2 is a block diagram illustrating a control configuration of the angle sensing device for a steering wheel according to the embodiment;

FIG. 3 is a graph illustrating a plurality of reference angle sections according to the embodiment;

FIG. 4 is a view illustrating a steering angle of a vehicle according to the steering wheel determined on the basis of an actual rotation angle of the steering wheel of the vehicle and an output signal from an angle sensor according to the embodiment;

FIG. 5 is a flowchart of an operation of the angle sensing device for a steering wheel according to the embodiment; and

FIG. 6 is a flowchart of an operation of the angle sensing device for a steering wheel according to the embodiment.

### DETAILED DESCRIPTION OF THE EMBODIMENT

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The disclosed disclosure proposes a steering system and a method of controlling the same based on a new technology, the angle sensing device that complements the related art in which an actual rotation angle of a steering wheel cannot be determined in case that the steering wheel rotates by an angle greater than a maximum rotation range of the steering wheel in response to an output signal from an angle sensor.

The actual rotation angle of the steering wheel, which is greater than a rotation angle of the steering wheel that may be determined in response to an output signal from the angle sensor, may be outputted as an uncertain value in an opposite direction because an overflow and/or an underflow.

For example, a rotation angle range, which cannot be determined in response to an output signal from the angle sensor, may be included in an uncertain rotation angle range that may be determined in response to the output signal from the angle sensor. In case that the rotation angle included in the uncertain rotation angle range is not an actual rotation angle of the steering wheel, a value of a rotation in an opposite direction may be outputted.

Therefore, the embodiment of the disclosed disclosure may compare a rotation angle of the steering wheel, which is determined as being included in the uncertain rotation angle range, with a yaw rate determined in response to an output signal from a yaw rate sensor of the vehicle and primarily validate the determined rotation angle of the steering wheel. Hereinafter, the embodiment of the disclosed disclosure is intended to provide a technology that determines a rotation angle corresponding to an actual rotation angle of the steering wheel by means of a state transition of the determined rotation angle of the steering wheel in case that the determined rotation angle of the steering wheel is not the actual steering rotation angle.

Hereinafter, operation principles and embodiments of the disclosed disclosure will be described in detail with reference to the accompanying drawings.

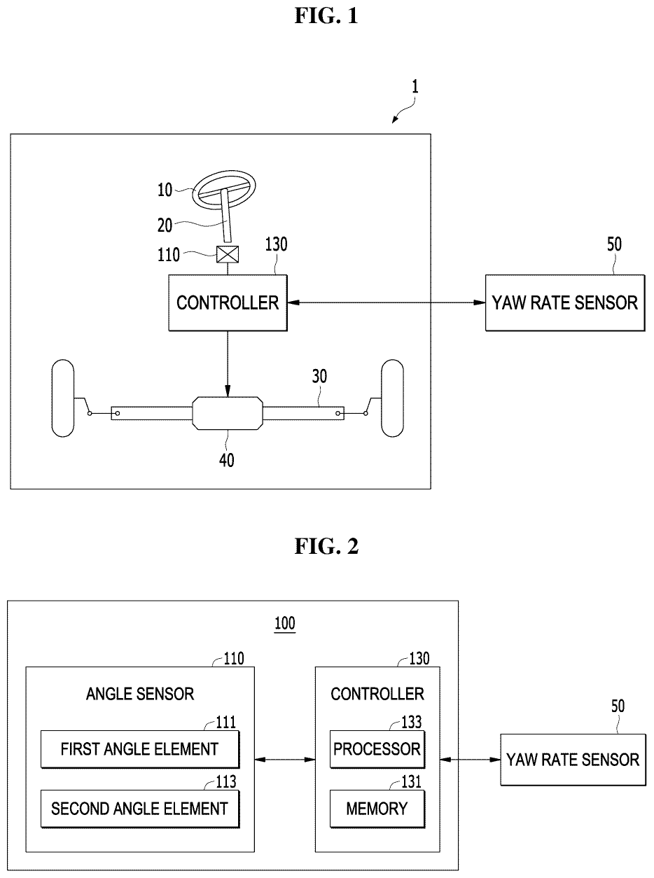

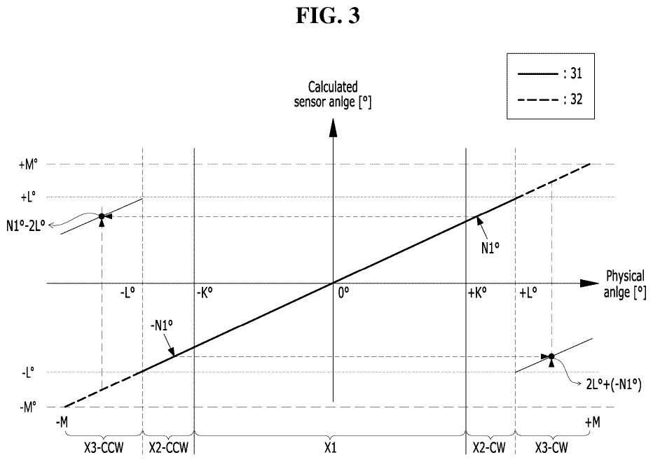

FIG. 1 is a view illustrating a steering system according to the embodiment. FIG. 2 is a block diagram illustrating a control configuration of an angle sensing device included in the steering system according to an embodiment. FIG. 3 is a graph illustrating a plurality of reference angle sections according to the embodiment. FIG. 4 is a view illustrating a steering angle of a vehicle according to the steering wheel determined on the basis of an actual rotation angle of the steering wheel of the vehicle and an output signal from an angle sensor according to the embodiment.

With reference to FIG. 1, a steering system 1 may include a steering wheel 10, a steering column 20, a rack bar assembly 30, a steering motor 40, an angle sensor 110, and/or a controller 130. The components illustrated in FIG. 1 are not essential components of the steering system 1, and at least some of the components illustrated in FIG. 1 may be excluded.

With reference to FIG. 2, the angle sensor 110 and the controller 130 of the steering system 1 may be control components of an angle sensing device 100 included in the steering system 1.

The steering wheel 10 may acquire a steering input made by a driver when the driver rotates the steering wheel 10 clockwise or counterclockwise.

The steering column 20 may support the steering wheel 10 and serve as a rotary shaft of the steering wheel 10. The steering column 20 may be rotated by the rotation of the steering wheel 10.

The rack bar assembly 30 may be connected to the steering column 20 and the wheels of the vehicle. The rack bar assembly 30 may be rectilinearly moved by an operation of the steering motor 40. The rack bar assembly 30 may change rotation directions of rotary shafts of the vehicle wheels to change a traveling direction of the vehicle. For example, the rack bar assembly 30 may rectilinearly move to rotate the rotary shaft of the wheel counterclockwise, such that the vehicle may be steered leftward. In addition, the rack bar assembly 30 may rectilinearly move to rotate the rotary shaft of the wheel clockwise, such that the vehicle may be steered rightward.

The steering motor 40 may be connected to the rack bar assembly 30 by a power conversion device and provide a rotational force for moving the rack bar assembly 30 rectilinearly. For example, the steering motor 40 may provide a rotational force for moving the rack bar assembly 30 leftward or rightward rectilinearly in response to a control signal from the controller 130. For example, the rotation of the steering motor 40 may be converted into a rectilinear motion by a rack gear, a pinion gear, and the like.

The angle sensor 110 may be provided as a single angle sensor or a plurality of angle sensors. The angle sensor 110 may detect the rotations of the steering wheel 10 and/or the steering column 20 made by the driver and outputs signals representing rotation angles of the steering wheel 10 and/or the steering column 20. For example, the angle sensor 110 may provide the controller 130 with electrical signals representing the rotation angles of the steering wheel 10 and/or the steering column 20.

With reference to FIG. 2, the angle sensor 110 may include one or more angle elements, e.g., a first angle element 111 and/or a second angle element 113. For example, maximum rotation ranges, which may be measured by the first angle element 111 and the second angle element 113, may be different from each other.

The first angle element 111 may be a Hall-type angle element.

For example, a magnet (not illustrated), which rotates in conjunction with the steering column 20, may be mounted on the steering column 20, and the first angle element 111 may be a Hall integrated circuit (IC). The first angle element 111 may convert a change in magnetic flux density of the magnet into an electrical signal and transmit the electrical signal to the controller 130.

The second angle element 113 may be an inductive angle element.

For example, the second angle element 113 may be a contactless inductive position sensor application specific integrated circuit (CIPOS ASIC) and may convert physical position information, which is made by the rotations of the steering wheel 10 and/or the steering column 20, into an electrical signal and transmit the electrical signal to the controller 130.

The controller 130 may be electrically connected or communication-connected to the angle sensor 110 and/or a yaw rate sensor 50 of the vehicle.

The controller 130 may receive an output signal from the angle sensor 110.

In response to the output signal received from the angle sensor 110, the controller 130 may determine the rotation angle of the steering wheel 10 and output the rotation angle.

The controller 130 may determine the rotation angle of the steering wheel 10 by means of a Vernier algorithm or a combination of the Vernier algorithm and an angle folsmaller algorithm in response to the output signals from the first and second angle elements 111 and 113. In this case, for example, a maximum rotation range of the steering wheel 10, which may be determined in response to the output signal from the first angle element 111, may be different from a maximum rotation range of the steering wheel 10 that may be determined in response to the output signal from the second angle element 113.

The Vernier algorithm is an algorithm that determines the rotation angle of the steering wheel 10 by combining two signals having different repetitive phases of the angle (or repetitive angles of the signals).

The combination of the Vernier algorithm and the angle folsmaller algorithm is an algorithm that obtains a position of the current steering wheel 10 on the basis of the Vernier algorithm and then determines the rotation angle of the steering wheel 10 on the basis of the angle folsmaller algorithm. The angle folsmaller algorithm may be an algorithm that calculates difference values (Delta angle) by comparing an output value of a previous signal and an output value of the current signal in respect to one of the two signals utilized to determine the rotation angle and then accumulates or adds up the difference value to the existing rotation angle value.

For example, in case that the maximum rotation range, which may be determined in response to the output signal from the first angle element 111, is 296° and the maximum rotation range, which may be determined in response to the output signal from the second angle element 113, is 40°, the controller 130 may determine the maximum rotation range, which may be determined as about 1480°, by applying the Vernier algorithm or the combination of the Vernier algorithm and the angle folsmaller algorithm in response to the output signals from the first and second angle elements 111 and 113.

Because the method of determining the rotation angle of the steering wheel 10 on the basis of the single Vernier algorithm and the combination of the Vernier algorithm and the angle folsmaller algorithm is the technology, a detailed description thereof will be omitted.

The controller 130 may adjust and store a position a center value of the entire rotation angle section (or also referred to as a ‘measurable rotation angle section’ or a ‘maximum rotation range’) of the steering wheel 10 that may be determined by the output range of the angle sensor 110, i.e., the first angle element 111 and the second angle element 113.

For example, the controller 130 may perform offset correction that sets the center value of the entire rotation angle section of the steering wheel 10, which may be determined in response to the output signal from the angle sensor 110, to 0. When the rotation angle section of the steering wheel 10 may be determined as 0° to A (A is an integer) in response to the output signal from the angle sensor 110, the controller 130 may adjust a range of the entire rotation angle section, which may be determined by the angle sensor 110, to −0.5A° to +0.5A°.

For example, in case that the rotation angle section, which may be measured by the steering wheel 10 in response to the output signal from the angle sensor 110, is 0° to +1480°, the controller 130 may adjust and store the range of the measurable rotation angle section to −740° to +740°.

The controller 130 may determine whether to apply the rotation angle of the steering wheel 10, which has been determined in response to the output signal from the angle sensor 110, to the actual rotation angle of the steering wheel 10.

As illustrated in FIG. 3, on the basis of a plurality of predesignated reference angle sections, the controller 130 may determine whether to apply the rotation angle of the steering wheel 10, which has been determined in response to the output signal from the angle sensor 110, to the actual rotation angle of the steering wheel 10.

In FIG. 3, the horizontal axis indicates physical angles corresponding to the actual rotation angles of the steering wheel 10, and the vertical axis indicates calculated angles corresponding to the determined rotation angles of the steering wheel 10 determined in response to the output signal from the angle sensor 110.

In FIG. 3, reference numeral 31 indicates the rotation angles of the steering wheel 10 that may be determined in response to the output signal from the angle sensor 110, and reference numeral 32 indicates the rotation angles that may be the actual rotation angles of the steering wheel 10, i.e., the rotation angles of the steering wheel 10 that cannot be outputted in response to the output signal from the angle sensor 110.

With reference to FIG. 3, the plurality of reference angle sections may include a first reference angle section X1, second reference angle sections X2-CW and X2-CCW, and third reference angle sections X3-CW and X3-CCW.

The first reference angle section X1 and the second reference angle sections X2-CW and X2-CCW may be the rotation angle sections of the steering wheel 10 that may be measured in response to the output signal from the angle sensor 110. The angle sensor 110 may output the signals corresponding to values included in the first reference angle section X1 and the second reference angle sections X2-CW and X2-CCW.

The first reference angle section X1 refers to a section in which an error between the actual rotation angle of the steering wheel 10 and the rotation angle of the steering wheel 10 determined in response to the output signal from the angle sensor 110 is within a predesignated reference error, i.e., a section in which the rotation angle of the steering wheel 10, which has been determined in response to the output signal from the angle sensor 110, to the actual rotation angle of the steering wheel 10.

In addition, the first reference angle section X1 means a section in which a sign of the rotation angle of the steering wheel 10 (or also referred to as a rotation direction of the steering wheel 10), which is determined in response to the output signal from the angle sensor 110, is identical to a sign of a yaw rate of the vehicle (or also referred to as a rotation direction of the vehicle) determined in response to the output signal from the yaw rate sensor 50.

A center value of the first reference angle section X1 may be 0, and a maximum value and a minimum value may be designated in advance as +K° (K is a real number) and −K°.

The second reference angle sections X2-CW and X2-CCW refer to sections in which an error between the actual rotation angle of the steering wheel 10 and the rotation angle of the steering wheel 10, which has been determined in response to the output signal from the angle sensor 110, is within a predesignated reference error or deviates from the predesignated reference error. That is, the second reference angle sections X2-CW and X2-CCW refer to sections in which the sign of the rotation angle of the steering wheel 10 (or also referred to as the rotation direction of the steering wheel 10), which is determined in response to the output signal from the angle sensor 110, may be identical to or different from the sign of the yaw rate (or also referred to as the rotation direction of the vehicle) determined by the yaw rate sensor 50.

This is because the rotation angle of the steering wheel 10, which has been determined in response to the output signal from the angle sensor 110, is one of the values of the second reference angle sections X2-CW and X2-CCW in case that the steering wheel 10 rotates beyond the entire rotation angle section of the steering wheel 10 determined in response to the output signal from the angle sensor 110. Therefore, the second reference angle sections X2-CW and X2-CCW refer to sections in which the rotation angle of the steering wheel 10, which has been determined in response to the output signal from the angle sensor 110, needs to be additionally validated.

In case that the rotation direction of the steering wheel 10 (or also referred to as the sign of the rotation angle), which is determined in response to the output signal from the angle sensor 110, is identical to the steering of the vehicle according to the yaw rate of the vehicle (or also referred to as the sign of the yaw rate) determined in response to the output signal from the yaw rate sensor 50 the rotation angle of the steering wheel 10 determined in response to the output signal from the angle sensor 110 is included in the second reference angle sections X2-CW and X2-CCW, an error between the actual rotation angle of the steering wheel 10 and the rotation angle of the steering wheel 10 determined in response to the output signal from the angle sensor 110 is within a predesignated reference error in the second reference angle sections X2-CW and X2-CCW.

In case that the rotation direction of the steering wheel 10, which is determined in response to the output signal from the angle sensor 110, is different from the steering of the vehicle according to the yaw rate determined in response to the output signal from the yaw rate sensor 50, an error between the actual rotation angle of the steering wheel 10 and the rotation angle of the steering wheel 10 determined in response to the output signal from the angle sensor 110 deviates from the predesignated reference error in the second reference angle sections X2-CW and X2-CCW.

The second reference angle sections X2-CW and X2-CCW include a second-first section X2-CW in which the rotation direction of the steering wheel 10 determined in response to the output signal from the angle sensor 110 is in a clockwise section (also referred to as a section in which the rotation angle of the steering wheel 10 is in a plus section). In case that the steering of the vehicle, which is determined in response to the output signal from the yaw rate sensor 50 in accordance with the yaw rate of the vehicle moving forward, is in a counterclockwise section (also referred to as a section in which the yaw rate is in a minus section), the actual rotation angle of the steering wheel 10 is included in a third-second section X3-CCW of the third reference angle sections X3-CW and X3-CCW to be described below. A detailed embodiment that calculates the actual rotation angle of the steering wheel 10 in the above-mentioned situation will be described below.

The second reference angle sections X2-CW and X2-CCW include a second-second section X2-CCW in which the rotation direction of the steering wheel 10 determined in response to the output signal from the angle sensor 110 is in the counterclockwise section (also referred to as a section in which the rotation angle of the steering wheel 10 is in the minus section). In case that the steering of the vehicle, which is determined in response to the output signal from the yaw rate sensor 50 in accordance with the yaw rate of the vehicle moving forward, is in the clockwise section (also referred to as a section in which the yaw rate is in the plus section), the actual rotation angle of the steering wheel 10 is included in a third-first section X3-CW of the third reference angle sections X3-CW and X3-CCW to be described below. A detailed embodiment that calculates the actual rotation angle of the steering wheel 10 in the above-mentioned situation will be described below.

The second reference angle sections X2-CW and X2-CCW may be designated in advance to include the second-first section X2-CW having a rotation angle of +K° to +L° in a section continuous from the first reference angle section X1, and the second-second section X2-CCW having a rotation angle of −K° to −L°. +K° may represent a first reference angle, and −K° may represent a second reference angle.

For example, +K° may be determined on the basis of an actual maximum rotation angle (+M°) of the steering wheel 10 predesignated on the basis of a maximum measured angle (+L°) that may be measured on the basis of a predesignated Vernier algorithm. For example, +K° may be 580° (=740°−(900°−740°)) in case that the maximum measured angle (+L°), which may be measured on the basis of the Vernier algorithm, is 740°, and the actual maximum rotation angle (+M°) of the steering wheel 10 is 900°.

−K° may be determined on the basis of an actual minimum rotation angle (−M°) of the steering wheel 10 predesignated on the basis of a minimum measured angle (−L°) that may be determined on the basis of the predesignated Vernier algorithm. For example, −K° may be −580° (=−740°−(−900°−(−740°))) in case that the minimum measured angle (−L°), which may be measured on the basis of the Vernier algorithm, is −740°, and the actual minimum rotation angle (−M°) of the steering wheel 10 is −900°.

For example, in case that the measurable rotation angle section of the steering wheel 10 is −740° to +740°, +L° of the second-first section X2-CW, which is the measurable maximum value of the second reference angle sections X2-CW and X2-CCW, is +740°, and −L° of the second-second section X2-CCW, which is the measurable minimum value of the second reference angle sections X2-CW and X2-CCW, is −740°.

The third reference angle sections X3-CW and X3-CCW are the rotation angle sections of the steering wheel 10 that cannot be determined in response to the output signal from the angle sensor 110. The angle sensor 110 cannot output the signals corresponding to values of the third reference angle sections X3-CW and X3-CCW.

The third reference angle sections X3-CW and X3-CCW may be designated in advance to include the third-first section X3-CW having a rotation angle of +L° to +M° in a section continuous from the second reference angle sections X2-CW and X2-CCW, and the third-second section X3-CCW having a rotation angle of −L° to −M°.

For example, based on +L°, a distance to K° and a distance to M° may be equal to each other. In addition, based on −L°, a distance to −K° and a distance to −M° may be equal to each other.

With reference to Table 1 below, the controller 130 may determine an actual angle section of the steering wheel 10 and/or a final rotation angle of the steering wheel 10 on the basis of a rotation angle θ of the steering wheel 10, which is determined in response to the output signal from the angle sensor 110, and a yaw rate Zyaw acquired in response to the output signal from the yaw rate sensor 50 according to the forward movement of the vehicle.

### [Table 1]

(the rotation angle of the steering wheel 10 determined in response to the output signal from the angle sensor 110: θ, the acquired yaw rate: Zyaw, a predesignated first reference yaw rate: −w, a predesignated second reference yaw rate: −w, the first reference angle: +K°, the second reference angle: −Ko, and the first reference yaw rate and the second reference yaw rate may be affected by a velocity of the vehicle and may be very large values in consideration of a steering state in an uncertain region.)

| Actual angle section of steering wheel 10 | Condition |
|---|---|
| Third-first section X3-CW | θ < −K° and Zyaw > −w |
| Second-first section X2-CW | θ > +K° and Zyaw >= +w |
| First reference angle section X1 | −K <= θ <= K |
| Second-second section X2-CCW | θ < −K° and Zyaw <= −w |
| Third-second section X3-CCW | θ > K° and Zyaw < +w |

With reference to Table 1 above, the controller 130 may determine that the rotation angle of the steering wheel 10 determined in response to the output signal from the angle sensor 110 is included in the first reference angle section X1 in case that the rotation angle of the steering wheel 10 determined in response to the output signal from the angle sensor 110 is the first reference angle (+K°) or less and the second reference angle (−K°) or more. Therefore, the controller 130 may determine that the rotation angle of the steering wheel 10 is determined in response to the output signal from the angle sensor 110 corresponds to the actual rotation angle of the steering wheel 10, i.e., determine that the rotation angle of the steering wheel 10 determined in response to the output signal from the angle sensor 110 is the final rotation angle.

The controller 130 may determine whether the rotation angle of the steering wheel 10 determined in response to the output signal from the angle sensor 110 corresponds to the actual rotation angle of the steering wheel 10 on the basis of the yaw rate acquired in response to the output signal from the yaw rate sensor 50 in case that the rotation angle of the steering wheel 10 determined in response to the output signal from the angle sensor 110 is greater than the first reference angle (+K°).

The controller 130 may determine that the actual rotation angle of the steering wheel 10 is included in the second-first section X2-CW between the second-first section X2-CW and the third-second section X3-CCW in case that the rotation angle of the steering wheel 10 determined in response to the output signal from the angle sensor 110 is greater than the first reference angle (+K°) and the acquired yaw rate is equal to or greater than the predesignated first reference yaw rate value (+w). Therefore, the controller 130 may determine the rotation angle of the steering wheel 10, which is determined in response to the output signal from the angle sensor 110, as the final rotation angle of the steering wheel 10.

The controller 130 may determine that the actual rotation angle of the steering wheel 10 is included in the third-second section X3-CCW between the third-second section X3-CCW and the second-first section X2-CW in case that the rotation angle of the steering wheel 10 determined in response to the output signal from the angle sensor 110 is greater than the first reference angle (+K°) and the acquired yaw rate is less than the predesignated first reference yaw rate value (+w). Therefore, the controller 130 may determine that the rotation angle of the steering wheel 10 determined in response to the output signal from the angle sensor 110 does not correspond to the actual rotation angle of the steering wheel 10.

FIG. 4A is a view illustrating a steering angle of a vehicle 1000 and the rotation direction of the steering wheel 10 when the actual rotation angle of the steering wheel 10 of the vehicle 1000 is +800° in the third-first section X3-CW. FIG. 4B is a view illustrating the steering angle of the vehicle 1000 and the rotation direction of the steering wheel 10 when the rotation angle of the steering wheel 10 determined in response to the output signal from the angle sensor 110 is −680° in the second-second section X2-CCW and the yaw rate determined in response to the output signal from the yaw rate sensor 50 is +w.

With reference to the comparison between FIGS. 4A and 4B, it can be seen that a difference between the actual rotation angle of the steering wheel 10 of the vehicle 1000 and the rotation angle of the steering wheel 10 determined in response to the output signal from the angle sensor 110 is significantly large. In addition, it can be seen that the actual rotation angle of the steering wheel 10 is 800° instead of −680° when the yaw rate sensor 50 outputs the yaw rate value, which is a very large value in the direction opposite to the rotation angle of the steering wheel 10 determined by the angle sensor 50 in a situation in which the rotation angle of the steering wheel 10 determined in response to the output signal from the angle sensor 110 is −680°.

Therefore, the controller 130 may perform additional computation so that the rotation angle of the steering wheel 10 determined in response to the output signal from the angle sensor 110 corresponds to the actual rotation angle of the steering wheel 10.

For example, the controller 130 may determine a value, which is made by adding up width value (2L°) in the first reference angle section X1 and the second reference angle sections X2-CW and X2-CCW and the rotation angle of the steering wheel 10 determined in response to the output signal from the angle sensor 110, as the actual rotation angle of the steering wheel 10.

With reference to FIG. 3, the controller 130 may determine a value, which is made by adding up 2L°, i.e., the width value in the first reference angle section X1 and the second reference angle sections X2-CW and X2-CCW and −N1°, as the actual rotation angle of the steering wheel 10 in case that the sign of the yaw rate is plus and the rotation angle of the steering wheel 10 determined in response to the output signal from the angle sensor 110 is −N1° with the minus sign.

The controller 130 may determine whether the rotation angle of the steering wheel 10 determined in response to the output signal from the angle sensor 110 corresponds to the actual rotation angle of the steering wheel 10 on the basis of the yaw rate acquired in response to the output signal from the yaw rate sensor 50 in case that the rotation angle of the steering wheel 10 determined in response to the output signal from the angle sensor 110 is smaller than the second reference angle (−K°).

The controller 130 may determine that the actual rotation angle of the steering wheel 10 is included in the second-second section X2-CCW between the second-second sections X2-CW and X2-CCW and the third-first section X3-CW in case that the rotation angle of the steering wheel 10 determined in response to the output signal from the angle sensor 110 is smaller than the second reference angle (−K°) and the acquired yaw rate is equal to or smaller than the predesignated second reference yaw rate (−w). Therefore, the controller 130 may determine the rotation angle of the steering wheel 10, which is determined in response to the output signal from the angle sensor 110, as the final rotation angle of the steering wheel 10.

The controller 130 may determine that the actual rotation angle of the steering wheel 10 is included in the third-first section X3-CW between the second-second section X2-CCW and the third-first section X3-CW in case that the rotation angle of the steering wheel 10 determined in response to the output signal from the angle sensor 110 is smaller than the second reference angle (−K°) and the acquired yaw rate is greater than the predesignated second reference yaw rate (−w). Therefore, the controller 130 may determine that the rotation angle of the steering wheel 10 determined in response to the output signal from the angle sensor 110 does not correspond to the actual rotation angle of the steering wheel 10.

FIG. 4C is a view illustrating the steering angle of the vehicle 1000 and the rotation direction of the steering wheel 10 when the actual rotation angle of the steering wheel 10 of the vehicle 1000 is −800° in the third-second section X3-CCW. FIG. 4D is a view illustrating the steering angle of the vehicle 1000 and the rotation direction of the steering wheel 10 when the rotation angle of the steering wheel 10 determined in response to the output signal from the angle sensor 110 is +680° in the second-first section X2-CW and the yaw rate determined in response to the output signal from the yaw rate sensor 50 is-w.

With reference to the comparison between FIGS. 4C and 4D, it can be seen that a difference between the actual rotation angle of the steering wheel 10 of the vehicle 1000 and the rotation angle of the steering wheel 10 determined in response to the output signal from the angle sensor 110 is significantly large. In addition, it can be seen that the actual rotation angle of the steering wheel 10 is −800° instead of +680° when the yaw rate sensor 50 outputs the yaw rate value, which is a very large value in the direction opposite to the rotation angle of the steering wheel 10 determined by the angle sensor 50 in a situation in which the rotation angle of the steering wheel 10 determined in response to the output signal from the angle sensor 110 is +680°.

Therefore, the controller 130 may perform additional computation so that the rotation angle of the steering wheel 10 determined in response to the output signal from the angle sensor 110 corresponds to the actual rotation angle of the steering wheel 10.

For example, the controller 130 may determine a value, which is made by subtracting the width value (2L°) in the first reference angle section X1 and the second reference angle sections X2-CW and X2-CCW from the rotation angle of the steering wheel 10 determined in response to the output signal from the angle sensor 110, as the actual rotation angle of the steering wheel 10.

With reference to FIG. 3, the controller 130 may determine a value, which is made by subtracting the width value of 2L° in the first reference angle section X1 and the second reference angle sections X2-CW and X2-CCW from N1°, as the actual rotation angle of the steering wheel 10 in case that the sign of the yaw rate is minus and the rotation angle of the steering wheel 10 determined in response to the output signal from the angle sensor 110 is N1° with the plus sign.

The controller 130 may determine the actual rotation angle of the steering wheel 10 on the basis of the reference angle section including the rotation angle of the steering wheel 10 determined in response to the output signal from the angle sensor 110 among the first reference angle section X1, the second reference angle sections X2-CW and X2-CCW, and the third reference angle sections X3-CW and X3-CCW illustrated in FIG. 3.

The controller 130 may determine the rotation angle of the steering wheel 10 determined in response to the output signal from the angle sensor 110 as the actual rotation angle of the steering wheel 10 in case that the rotation angle of the steering wheel 10 determined in response to the output signal from the angle sensor 110 is included in the first reference angle section X1.

The controller 130 may determine the rotation angle of the steering wheel 10 determined in response to the output signal from the angle sensor 110 as the actual rotation angle of the steering wheel 10 in case that the sign of the yaw rate acquired in response to the output signal from the yaw rate sensor 50 and the sign of the rotation angle of the steering wheel 10 determined in response to the output signal from the angle sensor 110 are identical to each other (or the rotation direction of the vehicle corresponding to the yaw rate and the rotation direction of the steering wheel corresponding to the rotation angle of the steering wheel 10 determined in response to the output signal from the angle sensor 110 are equal to each other) in case that the rotation angle of the steering wheel 10 determined in response to the output signal from the angle sensor 110 is included in the second reference angle sections X2-CW and X2-CCW.

In addition, the controller 130 may determine the actual rotation angle of the steering wheel 10 on the basis of the width value in the first reference angle section X1 and the second reference angle sections X2-CW and X2-CCW and the rotation angle of the steering wheel 10 determined in response to the output signal from the angle sensor 110 in case that the sign of the yaw rate acquired in response to the output signal from the yaw rate sensor 50 and the sign of the rotation angle of the steering wheel 10 determined in response to the output signal from the angle sensor 110 are different from each other (or the rotation direction of the vehicle corresponding to the yaw rate and the rotation direction of the steering wheel corresponding to the rotation angle of the steering wheel 10 determined in response to the output signal from the angle sensor 110 are different from each other) in case that the rotation angle of the steering wheel 10 determined in response to the output signal from the angle sensor 110 is included in the second reference angle sections X2-CW and X2-CCW.

For example, the width value (2L°) in the first reference angle section X1 and the second reference angle sections X2-CW and X2-CCW may be expressed as a value, which is made by subtracting the minimum value from the maximum value in the second reference angle sections X2-CW and X2-CCW, or expressed as a value of two times the maximum value. Therefore, the controller 130 may determine the actual rotation angle of the steering wheel 10 on the basis of the maximum value and/or the minimum value in the second reference angle sections X2-CW and X2-CCW and the rotation angle of the steering wheel 10 determined in response to the output signal from the angle sensor 110 in case that the sign of the yaw rate acquired in response to the output signal from the yaw rate sensor 50 and the sign of the rotation angle of the steering wheel 10 determined in response to the output signal from the angle sensor 110 are different from each other in case that the rotation angle of the steering wheel 10 determined in response to the output signal from the angle sensor 110 is included in the second reference angle sections X2-CW and X2-CCW.

For example, the controller 130 may determine the value, which is made by adding up the width value (2L°) in the first reference angle section X1 and the second reference angle sections X2-CW and X2-CCW and the rotation angle of the steering wheel 10 determined in response to the output signal from the angle sensor 110, as the actual rotation angle of the steering wheel 10 in case that the sign of the acquired yaw rate is plus (or the rotation direction of the vehicle corresponding to the acquired yaw rate is the clockwise direction) and the sign of the rotation angle of the steering wheel 10 determined in response to the output signal from the angle sensor 110 is minus (or the rotation direction of the vehicle corresponding to the acquired yaw rate is the counterclockwise direction).

For example, the controller 130 may determine that the actual rotation angle of the steering wheel 10 is 800° by performing computation of 1480°+(−680) ° in case that the angle section of the steering wheel 10, which may be measured in response to the output signal from the angle sensor 110, is −740° to +740° and the rotation angle of the steering wheel 10 determined in response to the output signal from the angle sensor 110 is −680° included in the second reference angle sections X2-CW and X2-CCW when the sign of the yaw rate is minus and different from the sign of the rotation angle of the steering wheel 10 determined in response to the output signal from the angle sensor 110.

In addition, the controller 130 may determine the value, which is made by subtracting the width value (2L°) in the first reference angle section X1 and the second reference angle sections X2-CW and X2-CCW from the rotation angle of the steering wheel 10 determined in response to the output signal from the angle sensor 110, as the actual rotation angle of the steering wheel 10 in case that the sign of the acquired yaw rate is minus (or the rotation direction of the vehicle corresponding to the acquired yaw rate is the counterclockwise direction) and the sign of the rotation angle of the steering wheel 10 determined in response to the output signal from the angle sensor 110 is plus (or the rotation direction of the vehicle corresponding to the acquired yaw rate is the clockwise direction).

For example, the controller 130 may determine that the actual rotation angle of the steering wheel 10 is −800° by performing computation of 680°-1480° in case that the angle section of the steering wheel 10, which may be measured in response to the output signal from the angle sensor 110, is −740° to +740° and the rotation angle of the steering wheel 10 determined in response to the output signal from the angle sensor 110 is 680° included in the second reference angle sections X2-CW and X2-CCW when the sign of the yaw rate is minus and different from the sign of the rotation angle of the steering wheel 10 determined in response to the output signal from the angle sensor 110.

The controller 130 may control the steering motor 40 on the basis of the steering angle of the steering wheel 10.

For example, the controller 130 may control the steering motor 40 so that the rack bar assembly 30 moves to a target position on the basis of the determined rotation angles of the steering wheel 10 and/or the steering column 20.

With reference to FIG. 2, the controller 130 may include a memory 131 and/or a processor 133.

The memory 131 may store or memorize programs (and/or algorithms) and data for implementing an operation of controlling the angle sensing device 100.

The memory 131 may store information on a maximum rotation range corresponding to a maximally rotatable range of the steering wheel 10.

The memory 131 may store information on an overall steering range and a maximum steering range of the steering wheel 10 that may be determined in response to the output signal from the angle sensor 110.

The memory 131 may store in advance information on the plurality of reference angle sections.

The memory 131 may provide the stored programs and data to the processor 133 and memorize temporary data generated during the operation of the processor 133. For example, the memory 131 may include volatile memories, such as a static random access memory (S-RAM) and a dynamic random access memory (D-RAM), and non-volatile memories, such as a read-only memory (ROM), an erasable programmable read-only memory (EPROM), and a flash memory.

The processor 133 may provide control signals for controlling the operations of the components included in the angle sensing device 100.

Meanwhile, in the above-mentioned embodiments, the configuration has been described in which the controller 130 determines the final rotation angle of the steering wheel 10 on the basis of the yaw rate acquired in response to the output signal from the yaw rate sensor 50 in accordance with the forward movement of the vehicle.

However, according to another embodiment, the controller 130 may determine the final rotation angle of the steering wheel 10 on the basis of the yaw rate acquired in response to the output signal from the yaw rate sensor 50 in accordance with the rearward movement of the vehicle.

More specifically, the controller 130 may determine the final rotation angle of the steering wheel 10 on the basis of the fact that the sign of the yaw rate determined when the vehicle moves forward is opposite to the sign of the yaw rate determined when the vehicle moves rearward.

For example, the controller 130 may determine the rotation angle determined in response to the output signal from the angle sensor 110 as the final rotation angle of the steering wheel 10 on the basis that the rotation angle determined in response to the output signal from the angle sensor 110 is greater than the first reference angle (+K°) and the yaw rate according to the rearward movement of the vehicle is equal to or smaller than the second reference yaw rate (−w) having a minus value.

In addition, the controller 130 may determine a value, which is made by subtracting a maximum rotation range value of the angle sensor 110 from the rotation angle determined in response to the output signal from the angle sensor 110, as the final rotation angle of the steering wheel 10 on the basis that the rotation angle determined in response to the output signal from the angle sensor 110 is greater than the first reference angle (+K°) and the yaw rate according to the rearward movement of the vehicle is greater than the second reference yaw rate (−w) having a minus value.

The controller 130 may determine the rotation angle determined in response to the output signal from the angle sensor 110 as the final rotation angle of the steering wheel 10 on the basis that the rotation angle determined in response to the output signal from the angle sensor 110 is smaller than the second reference angle (−K°) and the yaw rate according to the rearward movement of the vehicle is equal to or greater than the first reference yaw rate (+w) having a plus value.

In addition, the controller 130 may determine a value, which is made by adding up the rotation angle determined in response to the output signal from the angle sensor 110 and the maximum rotation range value of the angle sensor 110 as the final rotation angle of the steering wheel 10 in case that the rotation angle determined in response to the output signal from the angle sensor 110 is smaller than the second reference angle (−K°) and the yaw rate according to the rearward movement of the vehicle is smaller than the first reference yaw rate (+w) having a plus value.

As another example, the controller 130 may determine the rotation angle determined in response to the output signal from the angle sensor 110 as the final rotation angle of the angle sensing device 100 in case that the sign of the yaw rate acquired in response to the rearward movement of the vehicle and the sign of the rotation angle determined in response to the output signal from the angle sensor 110 are different from each other.

In addition, the controller 130 may determine a value, which is made by adding up the width value including the first and second reference angle sections and the determined rotation angle, as the final rotation angle of the angle sensing device 100 in case that the sign of the yaw rate acquired in accordance with the rearward movement of the vehicle is minus and the sign of the rotation angle determined in response to the output signal from the angle sensor 110 is minus.

The controller 130 may determine a value, which is made by subtracting the width value including the first and second reference angle sections from the rotation angle determined in response to the output signal from the angle sensor 110, as the final rotation angle of the angle sensing device 100 in case that the sign of the yaw rate acquired in accordance with the rearward movement of the vehicle is plus and the sign of the rotation angle determined in response to the output signal from the angle sensor 110 is plus.

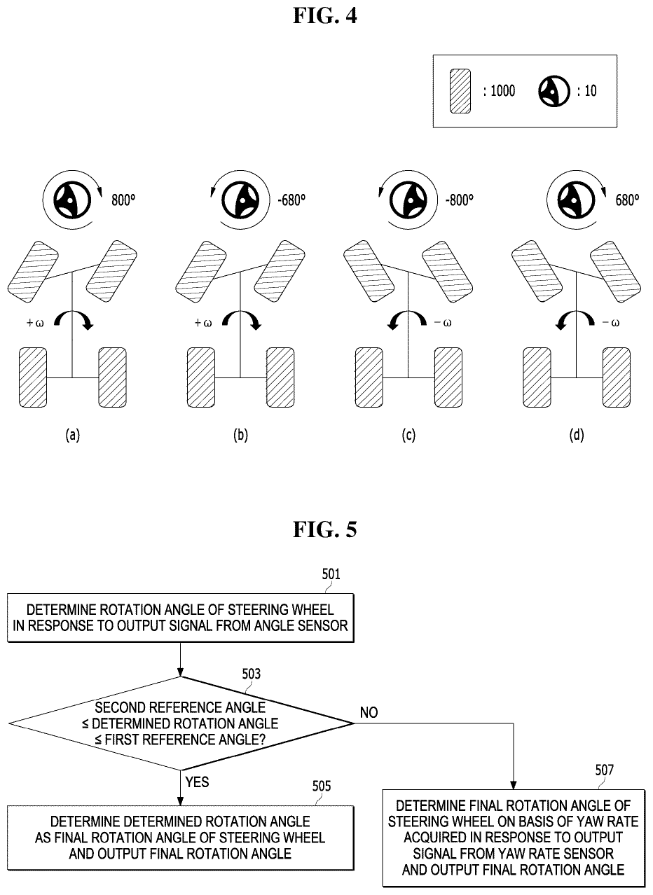

FIG. 5 is a flowchart of an operation of the angle sensing device 100 (and/or the controller 130) for the steering wheel 10 according to the embodiment.

With reference to FIG. 5, when the vehicle is turned on, the angle sensing device 100 may determine the rotation angle of the steering wheel 10 in response to the output signal from the angle sensor 110 (501).

The angle sensing device 100 may identify whether the determined rotation angle is the second reference angle or more and the first reference angle or less (503).

For example, the first reference angle may be the first reference angle (+K°) in FIG. 3, and the second reference angle may be the second reference angle (−K°) in FIG. 3.

The angle sensing device 100 may perform operation 505 in case that the determined rotation angle is the second reference angle or more and the first reference angle or less. Otherwise, the angle sensing device 100 may perform operation 507.

The angle sensing device 100 may determine the determined rotation angle as the final rotation angle of the steering wheel 10 and output the final rotation angle (505).

The angle sensing device 100 may determine the final rotation angle of the steering wheel 10 on the basis of the yaw rate acquired in response to the output signal from the yaw rate sensor 50 of the vehicle and output the final rotation angle of the steering wheel 10 (507).

For example, the angle sensing device 100 may acquire the yaw rate in response to the output signal from the yaw rate sensor 50 of the vehicle in accordance with a change in traveling or a change in direction of the vehicle during a short fraction of a second (e.g., less than 10 seconds or the like) at which the vehicle begins to travel after being turned on.

The angle sensing device 100 may determine the final rotation angle of the steering wheel 10 on the basis of the yaw rate acquired in accordance with the forward movement of the vehicle in case that the determined rotation angle is greater than the first reference angle or smaller than the second reference angle. For example, the angle sensing device 100 may determine the determined rotation angle as the final rotation angle of the steering wheel 10 when a condition in which the determined rotation angle is greater than the first reference angle (+K°) and the yaw rate is equal to or greater than the first reference yaw rate (+w) having a plus value is satisfied or a condition in which the determined rotation angle is smaller than the second reference angle (−K°) and the yaw rate is equal to or smaller than the second reference yaw rate (−w) having a minus value is satisfied.

In addition, the angle sensing device 100 may determine the value, which is made by subtracting the maximum rotation range value of the angle sensor 110 from the determined rotation angle, as the rotation angle of the steering wheel in case that the determined rotation angle is greater than the first reference angle (K°) and the acquired yaw rate is smaller than the first reference yaw rate (+w). In addition, the angle sensing device 100 may determine the value, which is made by adding up the determined rotation angle and the maximum rotation range value, as the rotation angle of the steering wheel 100 in case that the determined rotation angle is smaller than the second reference angle (−K°) and the acquired yaw rate is greater than the second reference yaw rate (−w).

The angle sensing device 100 may determine the final rotation angle of the steering wheel 10 on the basis of the yaw rate acquired in accordance with the rearward movement of the vehicle in case that the determined rotation angle is greater than the first reference angle or smaller than the second reference angle.

For example, the angle sensing device 100 may determine the determined rotation angle as the final rotation angle of the steering wheel 10 when a condition in which the determined rotation angle is greater than the first reference angle (+K°) and the yaw rate is equal to or smaller than the second reference yaw rate (−w) having a minus value is satisfied or a condition in which the determined rotation angle is smaller than the second reference angle (−K°) and the yaw rate is equal to or greater than the first reference yaw rate (−w) having a plus value is satisfied.

In addition, the angle sensing device 100 may determine the value, which is made by subtracting the maximum rotation range value of the angle sensor 110 from the determined rotation angle, as the rotation angle of the steering wheel in case that the determined rotation angle is greater than the first reference angle (K°) and the acquired yaw rate is greater than the second reference yaw rate (−w). In addition, the angle sensing device 100 may determine the value, which is made by adding up the determined rotation angle and the maximum rotation range value, as the rotation angle of the steering wheel 100 in case that the determined rotation angle is smaller than the second reference angle (−K°) and the acquired yaw rate is smaller than the first reference yaw rate (+w).

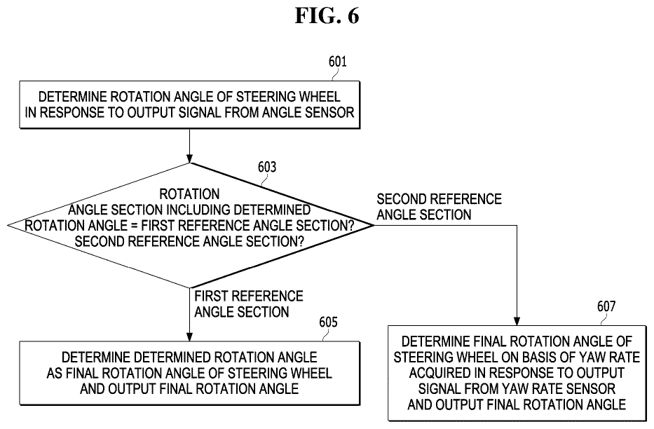

FIG. 6 is a flowchart of an operation of the angle sensing device 100 (and/or the controller 130) according to the embodiment.

With reference to FIG. 6, when the vehicle is turned on, the angle sensing device 100 may determine the rotation angle of the steering wheel 10 in response to the output signal from the angle sensor 110 (601).

The angle sensing device 100 may identify whether the determined rotation angle is included in the first reference angle section or the second reference angle section (603).

For example, the first reference angle section may be the first reference angle section X1 in FIG. 3, i.e., the section in which the rotation angle of the steering wheel 10 determined in response to the output signal from the angle sensor 110 corresponds to the actual rotation angle.

In addition, the second reference angle section may be the section continuous from the first reference angle section, i.e., the second reference angle sections X2-CW and X2-CCW in FIG. 3, and the second reference angle section is the section in which the rotation angle of the steering wheel 10 determined in response to the output signal from the angle sensor 110 may correspond to or may not correspond to the actual rotation angle.

The angle sensing device 100 may perform operation 605 in case that the determined rotation angle is included in the first reference angle section. Otherwise, the angle sensing device 100 may perform operation 607.

The angle sensing device 100 may determine the determined rotation angle as the final rotation angle of the steering wheel 10 (605).

The angle sensing device 100 may determine the final rotation angle on the basis of the yaw rate acquired in response to the output signal from the yaw rate sensor 50 of the vehicle (607).

The angle sensing device 100 may determine the determined rotation angle as the final rotation angle of the angle sensing device 100 in case that the sign of the yaw rate acquired in accordance with the forward movement of the vehicle and the sign of the determined rotation angle are identical to each other.

The angle sensing device 100 may determine a value, which is made by adding up the width value including the first and second reference angle sections and the determined rotation angle, as the final rotation angle of the angle sensing device 100 in case that the sign of the yaw rate acquired in accordance with the forward movement of the vehicle is plus and the sign of the determined rotation angle is minus.

The width value including the first and second reference angle sections refers to the maximum rotation range value of the steering wheel 10.

The angle sensing device 100 may determine the value, which is made by subtracting the width value including the first and second reference angle sections from the determined rotation angle, as the final rotation angle of the angle sensing device 100 in case that the sign of the yaw rate acquired in accordance with the forward movement of the vehicle is minus and the sign of the determined rotation angle is plus.

The angle sensing device 100 may determine the determined rotation angle as the final rotation angle of the angle sensing device 100 in case that the sign of the yaw rate acquired in accordance with the rearward movement of the vehicle and the sign of the determined rotation angle are different from each other.

The angle sensing device 100 may determine the value, which is made by adding up the width value including the first and second reference angle sections and the determined rotation angle, as the final rotation angle of the angle sensing device 100 in case that the sign of the yaw rate acquired in accordance with the rearward movement of the vehicle is minus and the sign of the determined rotation angle is minus.

The width value including the first and second reference angle sections refers to the maximum rotation range value of the steering wheel 10.

The angle sensing device 100 may determine the value, which is made by subtracting the width value including the first and second reference angle sections from the determined rotation angle, as the final rotation angle of the angle sensing device 100 in case that the sign of the yaw rate acquired in accordance with the rearward movement of the vehicle is plus and the sign of the determined rotation angle is plus.

The angle sensing device and the method of controlling the same according to the above-mentioned embodiment may provide a new technology capable of detecting the rotation range of the steering wheel greater than the maximum rotation range of the steering wheel that may be determined on the basis of the output value from the angle sensor.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. An angle sensing device, comprising:
one or more angle sensors configured to output an output signal corresponding to a rotation of a steering wheel of a vehicle; and
a controller connected to the one or more angle sensors,
wherein the controller is configured to:
determine a rotation angle of the steering wheel based on the output signal from the one or more angle sensors, and
based on a comparison of the determined rotation angle, a first reference angle, and a second reference angle smaller than the first reference angle,
determine the determined rotation angle as a final rotation angle of the steering wheel, or
determine the final rotation angle based on a yaw rate acquired from a yaw rate sensor of the vehicle in accordance with traveling of the vehicle.

2. The angle sensing device of claim 1, wherein the controller is configured to determine the determined rotation angle as the final rotation angle in response to the determined rotation angle being equal to or less than the first reference angle and being equal to or greater than the second reference angle.

3. The angle sensing device of claim 1, wherein the controller is configured to determine the final rotation angle based on the acquired yaw rate in response to the determined rotation angle being greater than the first reference angle or the determined rotation angle being smaller than the second reference angle.

4. The angle sensing device of claim 3, wherein the controller is configured to
determine the determined rotation angle as the final rotation angle in response to
the determined rotation angle being greater than the first reference angle, and
the yaw rate according to a forward movement of the vehicle being equal to or greater than a first reference yaw rate having a plus value, and
determine a value, which is obtained by subtracting a maximum rotation range value of the one or more angle sensors from the determined rotation angle, as the final rotation angle in response to
the determined rotation angle being greater than the first reference angle, and
the yaw rate according to the forward movement of the vehicle being smaller than the first reference yaw rate.

5. The angle sensing device of claim 3, wherein the controller is configured to
determine the determined rotation angle as the final rotation angle in response to
the determined rotation angle being greater than the first reference angle, and
the yaw rate according to a rearward movement of the vehicle being equal to or smaller than a second reference yaw rate having a minus value, and
determine a value, which is obtained by subtracting a maximum rotation range value of the one or more angle sensors from the determined rotation angle, as the final rotation angle in response to
the determined rotation angle being greater than the first reference angle, and
the yaw rate according to the rearward movement of the vehicle being greater than the second reference yaw rate.

6. The angle sensing device of claim 3, wherein the controller is configured to
determine the determined rotation angle as the final rotation angle in response to
the determined rotation angle being smaller than the second reference angle, and
the yaw rate according to a forward movement of the vehicle being equal to or smaller than a second reference yaw rate having a minus value, and
determine a value, which is obtained by adding up the determined rotation angle and a maximum rotation range value of the one or more angle sensors, as the final rotation angle in response to
the determined rotation angle being smaller than the second reference angle, and
the yaw rate according to the forward movement of the vehicle being greater than the second reference yaw rate.

7. The angle sensing device of claim 3, wherein the controller is configured to
determine the determined rotation angle as the final rotation angle in response to
the determined rotation angle being smaller than the second reference angle, and
the yaw rate according to a rearward movement of the vehicle being equal to or greater than a first reference yaw rate having a plus value, and
determine a value, which is obtained by adding up the determined rotation angle and a maximum rotation range value of the one or more angle sensors, as the final rotation angle in response to
the determined rotation angle being smaller than the second reference angle, and
the yaw rate according to the rearward movement of the vehicle being smaller than the first reference yaw rate.

8. An angle sensing device, comprising:
one or more angle sensors configured to output an output signal corresponding to a rotation of a steering wheel of a vehicle; and
a controller connected to the one or more angle sensors,
wherein the controller is configured to:
determine a rotation angle of the steering wheel based on the output signal from the one or more angle sensors, and
in accordance with a reference angle section including the determined rotation angle among a plurality of reference angle sections,
determine the determined rotation angle as a final rotation angle of the steering wheel, or
determine the final rotation angle based on a yaw rate acquired from a yaw rate sensor of the vehicle in accordance with traveling of the vehicle.

9. The angle sensing device of claim 8, wherein the controller is configured to determine the determined rotation angle as the final rotation angle in response to the determined rotation angle being included in a first reference angle section among the plurality of reference angle sections.

10. The angle sensing device of claim 9, wherein the controller is configured to determine the final rotation angle based on a comparison between the acquired yaw rate and the determined rotation angle, in response to the determined rotation angle being included in a second reference angle section continuous from the first reference angle section among the plurality of reference angle sections.

11. The angle sensing device of claim 10, wherein the controller is configured to
determine the determined rotation angle as the final rotation angle, in response to a sign of the acquired yaw rate in accordance with a forward movement of the vehicle being identical to a sign of the determined rotation angle, and
determine the final rotation angle based on the determined rotation angle and a width value including the first reference angle section and the second reference angle section, in response to the sign of the acquired yaw rate in accordance with the forward movement of the vehicle being different from the sign of the determined rotation angle.

12. The angle sensing device of claim 10, wherein the controller is configured to determine a value, which is obtained by adding up the determined rotation angle and a width value including the first reference angle section and the second reference angle section, as the final rotation angle, in response to a sign of the acquired yaw rate in accordance with a forward movement of the vehicle being plus and a sign of the determined rotation angle being minus.

13. The angle sensing device of claim 12, wherein the controller is configured to determine a value, which is obtained by subtracting the width value from the determined rotation angle, as the final rotation angle, in response to the sign of the acquired yaw rate in accordance with the forward movement of the vehicle being minus and the sign of the determined rotation angle being plus.

14. The angle sensing device of claim 10, wherein the controller is configured to
determine the determined rotation angle as the final rotation angle, in response to a sign of the acquired yaw rate in accordance with a rearward movement of the vehicle being different from a sign of the determined rotation angle, and
determine the final rotation angle based on the determined rotation angle and a width value including the first reference angle section and the second reference angle section, in response to the sign of the acquired yaw rate in accordance with the rearward movement of the vehicle being identical to the sign of the determined rotation angle.

15. The angle sensing device of claim 10, wherein the second reference angle section comprises:
a first range to a value increased by a preset value from a maximum value of the first reference angle section; and
a second range to a value decreased by the preset value from a minimum value of the first reference angle section.

16. The angle sensing device of claim 15, wherein
a center value of an entire rotation section of the steering wheel is set to 0, the entire rotation section being a maximum rotation range of the steering wheel that is measurable based on the output signal from the one or more angle sensors, and
a width value of the first reference angle section is a value obtained by subtracting a value, which is obtained by dividing a maximum rotation range value of the steering wheel by 2, from a width value of the entire rotation section.

17. A method of controlling an angle sensing device, the method comprising:
determining a rotation angle of a steering wheel of a vehicle based on an output signal from one or more angle sensors, the output signal corresponding to a rotation of the steering wheel; and
based on a comparison of the determined rotation angle, a first reference angle, and a second reference angle smaller than the first reference angle,
determining the determined rotation angle as a final rotation angle of the steering wheel, or
determining the final rotation angle based on a yaw rate acquired from a yaw rate sensor of the vehicle in accordance with traveling of the vehicle.

18. The method of claim 17, wherein
the determining of the determined rotation angle as the final rotation angle is performed in response to the determined rotation angle being equal to or less than the first reference angle and being equal to or greater than the second reference angle, and
the determining of the final rotation angle based on the acquired yaw rate is performed in response to the determined rotation angle being greater than the first reference angle or the determined rotation angle being smaller than the second reference angle.

19. The method of claim 18, wherein the determining of the final rotation angle based on the acquired yaw rate comprises determining the determined rotation angle as the final rotation angle
in response to the determined rotation angle being greater than the first reference angle, and the yaw rate according to a forward movement of the vehicle being equal to or greater than a first reference yaw rate having a plus value, or
in response to the determined rotation angle being smaller than the second reference angle, and the yaw rate according to the forward movement of the vehicle being equal to or smaller than a second reference yaw rate having a minus value.

20. The method of claim 18, wherein the determining of the final rotation angle based on the acquired yaw rate comprises:
determining a value, which is obtained by subtracting a maximum rotation range value of the one or more angle sensors from the determined rotation angle, as the final rotation angle of the steering wheel in response to
the determined rotation angle being greater than the first reference angle, and
the yaw rate according to a forward movement of the vehicle being smaller than a first reference yaw rate; and
determining a value, which is obtained by adding up the determined rotation angle and the maximum rotation range value, as the final rotation angle of the steering wheel in response to
the determined rotation angle being smaller than the second reference angle, and
the yaw rate according to the forward movement of the vehicle being greater than a second reference yaw rate.
